(19) United States
(12) Patent Application Publication
(10) Pub. No.: US 2024/0162830 A1
(43) Pub. Date: May 16, 2024

(54) DIRECT DRIVE LEDS USING FLOATING SWITCHES IN 3-PHASE OR SINGLE-PHASE RECTIFIER CIRCUIT

(71) Applicant: INVENT10 LIMITED, Hong Kong (CN)

(72) Inventor: Kam Wah SIU, Hong Kong (CN)

(73) Assignee: INVENT10 LIMITED, Hong Kong (CN)

(21) Appl. No.: 17/985,915

(22) Filed: Nov. 14, 2022

(51) Int. Cl. H02M 7/155; H05B 45/325; H05B 45/36

(52) U.S. Cl. CPC H02M 7/1552; H05B 45/325; H05B 45/36; H05B 45/48

(57) ABSTRACT

Embodiments of the invention provide a 3-phase rectifying circuit that may produce a DC voltage with much less ripple compared to a single-phase rectifying circuit. In one aspect, the circuit or switch of embodiments of the invention may provide a filtered DC voltage to drive a LED string formed by multiple LED units.

### FIELD OF THE INVENTION

Aspects of the invention generally relate to LED control design. More specifically, embodiments of the invention relate to improved switches and circuit configurations.

### BACKGROUND

Horticulture technology has involved over the years when consumers' food consumption habits are changing. The health benefits of consumption of vegetables have in focus in recent years, and the businesses are creating different ways to increase yield.

Despite different areas of focus within the science of horticulture, such as olericulture, pomology or fruticulture, floriculture, or the like, most of the focus is on using existing technologies, such as a lighting system, and a sprinkler irrigation system. Further circuitry or power control devices used therein are often off-the-shelf purchase, so the management of the overall system has various shortcomings.

### SUMMARY OF THE INVENTION

Embodiments of the invention provide a 3-phase rectifying circuit that may produce a DC voltage with much less ripple compared to a single-phase rectifying circuit. In one aspect, the circuit or switch of embodiments of the invention may provide a filtered DC voltage to drive a LED string formed by multiple LED units.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a schematic of a light emitting diode (LED) string powered by an inductor filtered 3-phase rectifier according to prior art.

FIG. 2 is a graph showing a voltage and current waveforms at 380 Vac source voltage according to according to FIG. 1.

FIG. 3 is a graph showing a voltage and current waveforms when a source voltage is increased by 10% according to FIG. 1.

FIG. 4 is a graph showing a voltage and current waveforms at an increased source voltage according to FIG. 1.

FIG. 5 is a schematic of an improved LED driving circuitry according to one embodiment.

FIG. 6 is another schematic of an improved LED circuitry according to one embodiment.

FIG. 7 is a schematic of a LED circuitry with a pulse-width modulation (PWM) switching LED unit according to one embodiment.

FIG. 8 is a schematic for a LED circuitry of a 220Vac single phase power source in LED circuitries according to one embodiment.

FIG. 9 is a schematic of a LED circuitry for color mixing according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

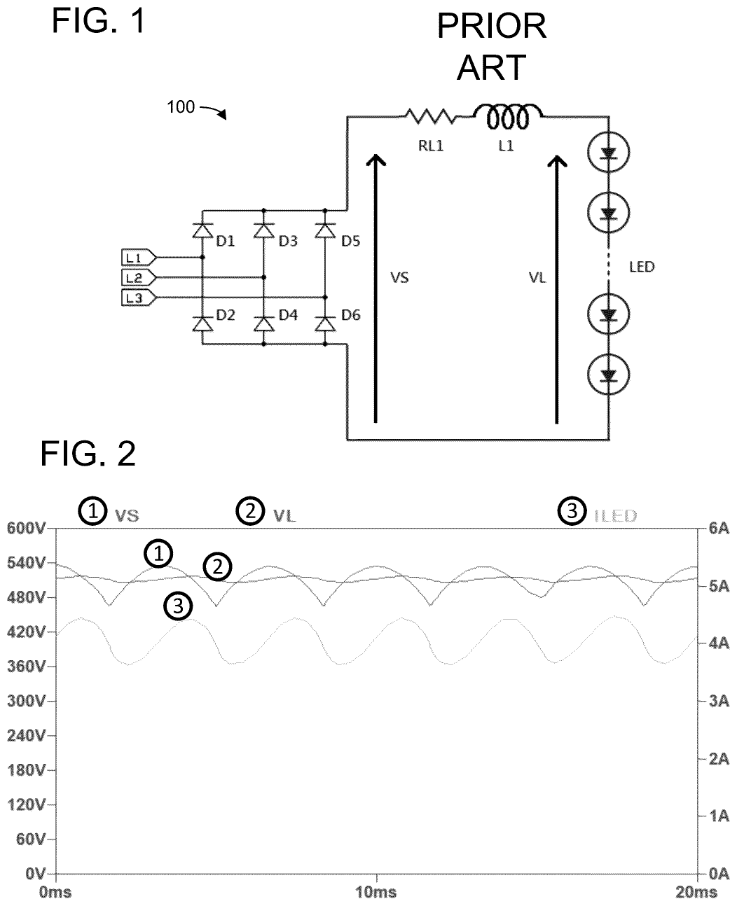

Referring now to FIG. 1, a schematic of a light emitting diode (LED) string powered by an inductor filtered 3-phase rectifier according to prior art. In one aspect, a circuit 100 may be a simple and very efficient circuit to drive LEDs. In one aspect, the LEDs may be used in a horticulture setting where a web of LEDs may be deployed across a large area of cultivated space. In the prior approach, a single inductor with its internal resistance limits an amount of current through the LED string and its inductance filters the current ripple. For a fixed source voltage, however, a lower internal resistance produces higher LED current, a larger inductance produces less current ripple.

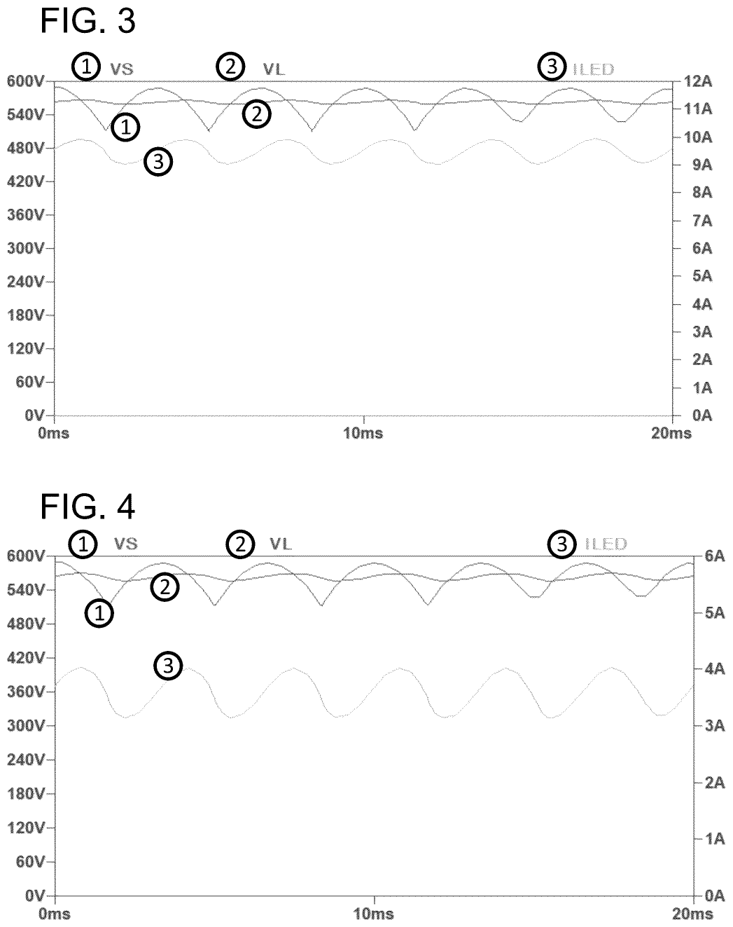

However, the voltage of a 3-phase AC power source is not always a constant value. Referring now to FIG. 2, a graph shows a voltage and current waveforms at 380Vac according to FIG. 1. In one aspect, a supply voltage (VS) curve is labeled 1, a load voltage (VL) curve is labeled 2 and a LED current (ILED) curve is labeled 3. When the source voltage is increased by 10%, as shown in FIG. 3, the LED current will be increased to more than double to achieve a higher LED forward voltage, as seen by the position of the curve 3 in FIG. 3.

In one aspect, to maintain the LED power constant for the increased source voltage, more LED units are needed to produce a higher forward voltage at normal LED current. As such, as shown in FIG. 4, a graph shows the waveforms when 10% more LED units are added to the LED string. As such, when compared to waveforms in FIG. 2, one can easily recognized that the LED voltage VL curve 2 is increased by about 10% and the LED current as shown in curve 3 is decreased by about 10% such that the LED power is about the same.

Similarly, based on the above showing, LED units should be removed from the LED string when the source voltage is decreased. Table 1 shows the number of LEDs in the string, LED current, ripple percentage, input power and power factor for different source voltages with a 33 mH inductor L1.

TABLE 1
Parameters for FIG. 1 at different source voltages.

| Source | No. of | LED | | | |
|---|---|---|---|---|---|
| Voltage/ | LEDs in | current/ | Current | Input | Power |
| Vac | string | A | Ripple/% | Power/W | Factor |
| 380 + 10% | 158 | 3.61 | 25.7 | 2028 | 0.958 |
| 380 + 5% | 150 | 3.84 | 23.2 | 2048 | 0.961 |
| 380 | 142 | 4.07 | 20.6 | 2076 | 0.964 |
| 380 − 5% | 135 | 4.21 | 19.5 | 2020 | 0.960 |
| 380 − 10% | 127 | 4.33 | 18.3 | 1990 | 0.959 |

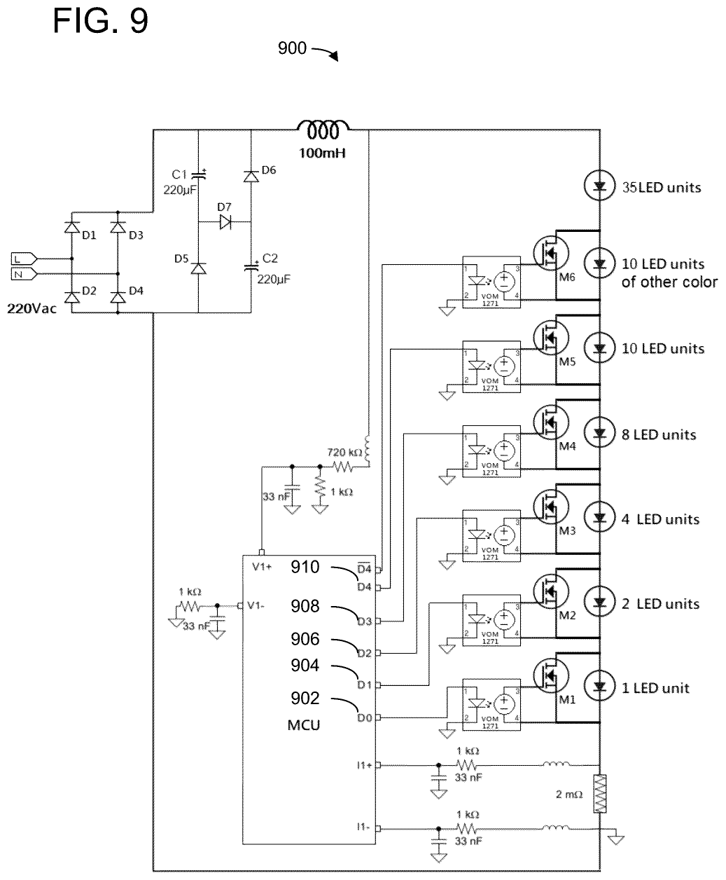

In order to regulate the LED power for inductor filtered rectifiers at various source voltages, aspects of the invention add bypass switches to some LED units in the LED string such that the forward voltage of the LED string can be changed to control the LED power. IN addition, to avoid light flickers during switch transition, a pulse width modulated (PWM) switching is added to the bypass switches. Additional bypass switches connected to different color LEDs may also be added for color change purposes, as shown later in FIG. 9.

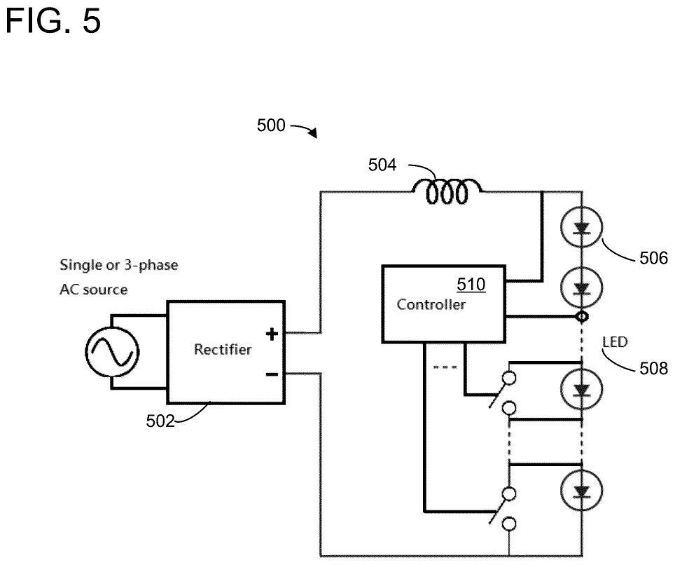

FIG. 5 shows a schematic diagram of an improved LED driving circuitry 500 according to one embodiment. In one embodiment, a rectifier 502 is added to convert a single phase or 3-phase AC voltage into a ripple DC voltage. In one aspect, an inductor 504 may be used to limit the current and filters the ripple. A LED string 508 may have at least one switch 506 in parallel connected with one or more LED units 508. A controller 510 may sense the LED voltage and current to compute the LED power needed. As the LED power deviates from its nominal value or voltage (e.g. due to source voltage fluctuation), the controller 510 may increase or decrease the LED forward voltage, by switching off or on the bypass switches 506 respectively, to adjust the LED power back to the nominal value or voltage.

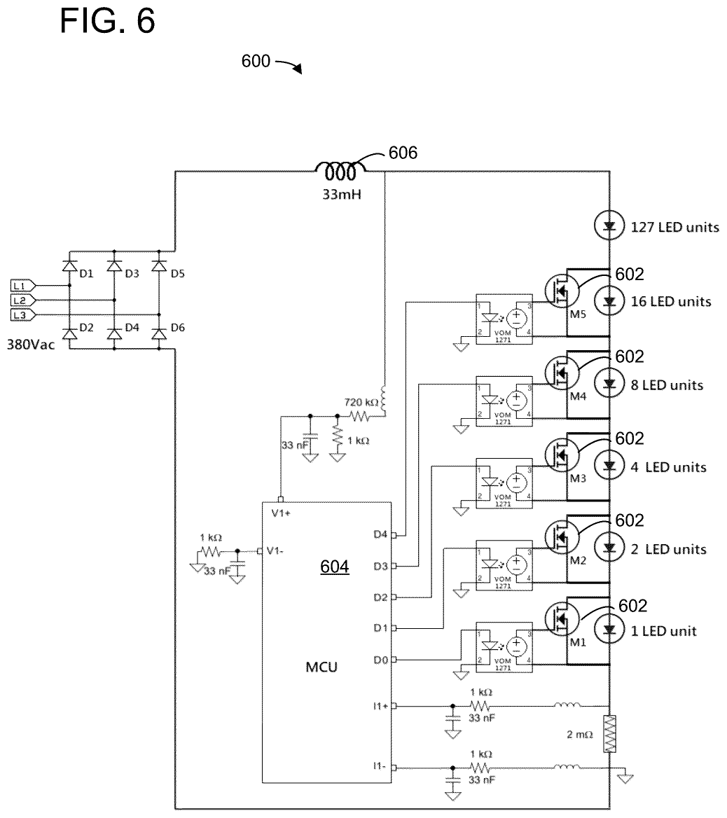

FIG. 6 shows another example schematic of an improved LED driving circuitry 600 according to one embodiment. In this example, 5 bypass metal-oxide-semiconductor field-effect transistors (MOSFETs) (abbreviated as M1, M2, M3, M4 and M5 below) 602 may be placed in parallel connection to 1, 2, 4, 8, 16 LED units. Each MOSFET 602 may drive by an isolated driver VOM1271. A microcontroller unit (MCU) 604 may send or transmit a signal to drive or control the on-off state of the MOSFETs 602. By setting different on-off state of the 5 MOSFETs 602, different LED forward voltage (in steps of one LED unit) may be selected. As such, there may be 32 different forward voltage options ranging from voltage of 127 units (all MOSFETs are on) to 158 units (all MOSFETs are off).

In another embodiment, suppose the AC source voltage is 380Vac, the controller 604 may turn off M1, M2, M3, M4 and turn on M5 such that the number of LED units of the whole LED string is 142 (1+2+4+8+127). When the AC source voltage begins to increase, the LED power may increase too. When the LED power is increased by a threshold value such that an additional LED unit is required in the LED string to decrease the LED power to nominal range, the controller 604 may turn off M5 and turn on M1, M2, M3, M4. The number of LED units of the whole LED string becomes 143 (16+127).

Similarly, if the AC source voltage begins to decrease from 380Vac, the LED power will decrease too. When the LED power is decreased by a threshold value such that an LED unit is required to be removed in the LED string to increase the LED power to nominal range, the controller may turn off M2, M3, M4 and turn on M1, M5. The number of LED units of the whole LED string becomes 141 (2+4+8+127).

The MCU 604 may regulate the LED power for a source voltage range of 380Vac−10% to 380Vac+10% by setting the 32 steps of LED forward voltage. It may be noted that the number of switches, the number of LED units connected to each switch and the implementation of the controller in this example are for reference only. Different designs may use any switch-LED configurations and controller implementations without departing from the scope or spirit of the invention.

In one aspect, while an inductor 606 may filter the LED current ripples, it may also resist a change in the average current flow. When source voltage drops, the LED forward voltage may be decreased to increase LED current. However, as the number of LEDs decreases (say from 142 LED units to 141 LED units), the average LED current will not increase immediately, it may take some time (defined by the time constant Lift L is inductance and R is internal resistance of the inductor 606) before the average LED current reaches a steady state value. In fact, the LED current stays unchanged when the change of LED forward voltage occurs. Instead of increase LED power, there may be a sudden drop of LED power (about 7%) when number of LEDs changes from 142 to 141 LED units. This power drop may cause a perceptible light flicker to human eyes.

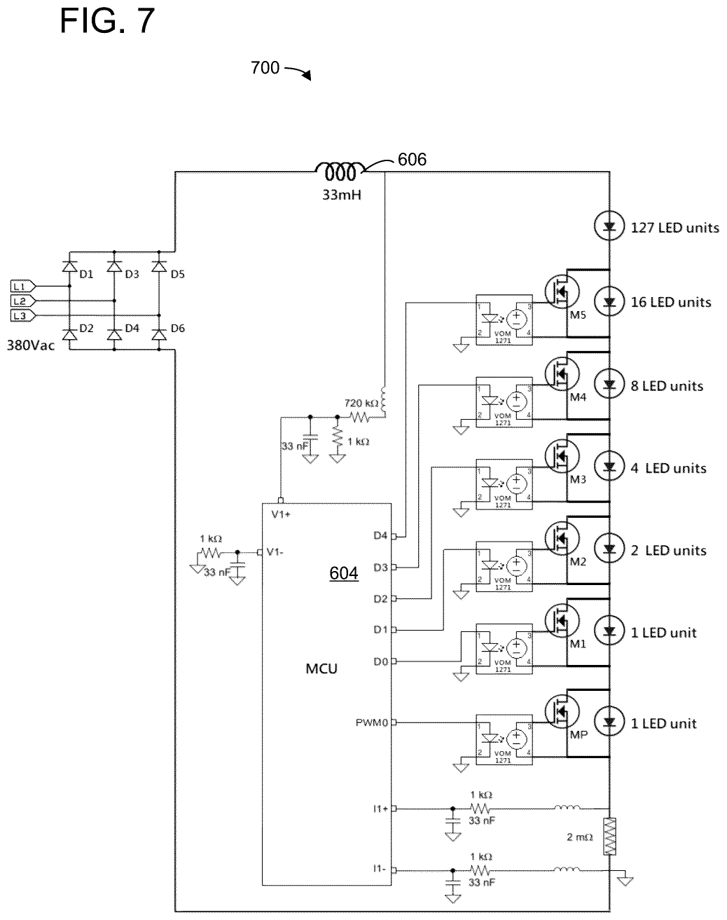

Aspects of the invention may alleviate or avoid this potential light flicker. In one embodiment, instead of direct hard switching the LED units as in FIG. 6, a pulse width modulated (PWM) switching LED unit may be added to smoothen the transition, as shown in FIG. 7. FIG. 7 is a schematic of an LED circuit 700 with a pulse-width modulation (PWM) switching LED unit according to one embodiment. While the PWM switching LED unit may appear to be identical to one of the LED units with MOSFET M1 in FIG. 6, the PWM switching may also be applied to MOSFETs M1 to M5 in FIG. 6 to smoothen the transition. However, in smoothing the transition, one may involve PWM switching (at a frequency above 100 Hz) of 31 LED units, which is not perceptible by human eyes but may cause dark stripes or bands on camera images and videos. As such, it may be preferable to PWM switching just 1 LED unit out of 142 units.

In one aspect, a MOSFET MP may be energized. In one aspect, when AC source voltage decreases from 380Vac to a point that an LED unit is required to be removed in the LED string to increase the LED power, the controller may turn off MP, M2, M3, M4 and may turn on M1, M5 such that the number of LED units of the whole LED string is still 142. In another embodiment, the controller may start to engage PWM to switch the MOSFET MP from 0% (fully off) gradually up to 100% (fully on) in a period of time (say multiple of the L/R time constant) while keeping the states of other MOSFETs unchanged. By the end of the PWM switching period, MOSFET MP may be fully turned on and there are 141 LED units in the whole LED string. The controller then may switch off M2, M3, M4 and turn on MP, M1, M5. The number of LED units of the whole LED string keeps or maintains as 141. With PWM switching a LED unit as an intermediate state of the transition, sudden LED power change may be alleviated or removed.

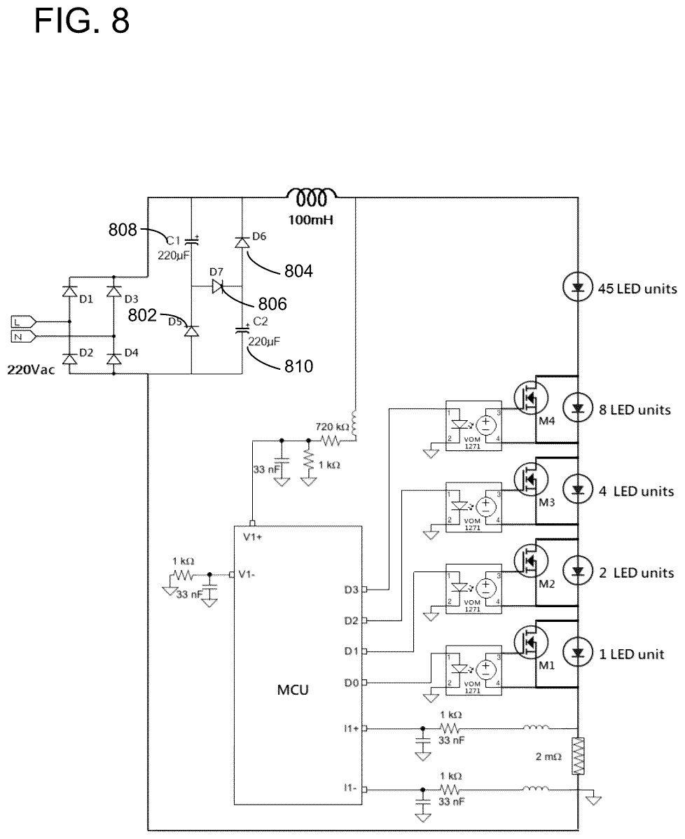

In one embodiment, FIG. 8 is a schematic for an LED circuit of a 220Vac single phase power source in LED circuitries according to one embodiment. In one aspect, an optional valley fill circuit formed by diodes D5 802, D6 804, D7 806 and capacitors C1 808, C2 810 are used to reduce voltage ripple of rectifying circuit D1-D4 by about 50%. In one example, the 100 mH inductor may further reduce the ripple. Table 2 below shows the total number of LED units in the LED string and other parameters for schematic in FIG. 8 at different source voltages. The controller may control the number of LED units in the range of 45 to 60 to regulate the LED power for a source voltage range of 220Vac−10% to 220Vac+10%.

TABLE 2
Parameters for schematic in FIG. 8 at different source voltages.

| Source | No. of | LED | | | |
|---|---|---|---|---|---|
| Voltage/ | LEDs in | current/ | Current | Input | Power |
| Vac | string | A | Ripple/% | Power/W | Factor |
| 220 + 10% | 60 | 8.36 | 43.0 | 1982 | 0.950 |
| 220 | 53 | 9.67 | 37.4 | 2067 | 0.949 |
| 220 − 10% | 46 | 11.45 | 27.4 | 2175 | 0.944 |

It is to be understood that the LEDs in the string is not limited to a single color or even in the same light spectrum. Multi-color LEDs may be used to change the color or color temperature of the LED light. In one aspect, bypass switches may be used to swap different color LEDs with similar forward voltages.

In one aspect, FIG. 9 shows an example of a schematic of a LED circuitry for color mixing according to one embodiment. In one example, MOSFETs M5 and M6 may be complementary switches. In this example, the MOSFET M5 is on when MOSFET M6 is off and vice versa. Such arrangement may enable 10 units of other color LED to be swapped with 10 units of original LEDs. The controller may use D4 910 to control the swap and DO 902 to D3 908 to regulate the LED power.

It is to be understood that the number of switches (for color change or power control), the number of LED units connected to each switch and the implementation of the controller in the present disclosure are for example and for reference only. Different designs can use any switch-LED configurations and controller implementations without departing from the scope or spirit of the invention.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, aspects of the invention provide an improved LED circuitry or control schematics for more efficiently regulate, control or manage LED lights.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A circuit for one or more light emitting diode (LED) units comprising:
a single phase or a 3-phase alternating current (AC) voltage as a power source;
a rectifier for converting the single phase or 3-phase AC voltage into a ripple DC voltage;
an inductor for limiting a current in the circuit, wherein the inductor is configured to filter the ripple DC voltage;
one or more switch connecting in parallel with the one or more LED units in the circuit;
a controller for sensing a LED voltage and a LED current to compute a LED power;
wherein the controller is configured to regulate a LED forward voltage as a function of a deviation from a nominal voltage value; and
wherein the controller is configured to energize or de-energize the one or more switch to adjust the LED power back to the nominal voltage value.

2. The circuit of claim 1, wherein the one or more switch comprises one or more metal-oxide-semiconductor field-effect transistor (MOSFET).

3. The circuit of claim 2, wherein the one or more MOSFET comprises a pulse-width modulation (PWM) switching.

4. The circuit of claim 2, wherein the controller is further configured to energize the MOSFET for color mixing of the one more LED units.

5. The circuit of claim 1, wherein the controller comprises a microcontroller unit (MCU).

6. The circuit of claim 1, further comprising one or more diodes and capacitors for reducing voltage ripple.

7. The circuit of claim 1, wherein the one or more LED units comprise one or more different colors.

8. A system for one or more light emitting diode (LED) units comprising:
a single phase or a 3-phase alternating current (AC) voltage as a power source;
a rectifier for converting the single phase or 3-phase AC voltage into a ripple DC voltage;
an inductor for limiting a current in the circuit, wherein the inductor is configured to filter the ripple DC voltage;
one or more switch connecting in parallel with the one or more LED units in the circuit;
a controller for sensing a LED voltage and a LED current to compute a LED power;
wherein the controller is configured to regulate a LED forward voltage as a function of a deviation from a nominal voltage value; and
wherein the controller is configured to energize or de-energize the one or more switch to adjust the LED power back to the nominal voltage value.

9. The system of claim 8, wherein the one or more switch comprises one or more metal-oxide-semiconductor field-effect transistor (MOSFET).

10. The system of claim 9, wherein the one or more MOSFET comprises a pulse-width modulation (PWM) switching.

11. The system of claim 9, wherein the controller is further configured to energize the MOSFET for color mixing of the one more LED units.

12. The system of claim 8, wherein the controller comprises a microcontroller unit (MCU).

13. The system of claim 8, further comprising one or more diodes and capacitors for reducing voltage ripple.

14. The system of claim 8, wherein the one or more LED units comprise one or more different colors.
